(19) United States
(12) Patent Application Publication
(10) Pub. No.: US 2018/0042425 A1
(43) Pub. Date: Feb. 15, 2018

(54) Crock Pot Bag

(71) Applicant: Michelle True-Hobbs, Anchorage, AK (US)

(72) Inventor: Michelle True-Hobbs, Anchorage, AK (US)

(21) Appl. No.: 15/231,825

(22) Filed: Aug. 9, 2016

(51) Int. Cl. A47J 36/16; B65D 33/25; B65D 33/00; B65D 81/34

(52) U.S. Cl. CPC A47J 36/16; B65D 81/34; B65D 33/2591; B65D 33/004

(57) ABSTRACT

The present invention is a reusable silicone container or bag in the shape of the most commonly used crock pots (oval or round according to the dimensions of the specific crock pots). It would have a fully sealable zipper that would make it easy to fill, and empty even when frozen. It would be extremely easy to lift out of the crock pot and just flip inside out to dump contents, clean and re-use. In the preferred embodiment, it would have a label spot to label the contents of the bag and date created.

### CROSS-REFERENCES TO RELATED APPLICATIONS (IF ANY)

None

### BACKGROUND

### 1. Field of the Invention

The invention relates to a bag for cooking in particular, one that can be frozen and heated and used with crock pots.

### 2. Description of Prior Art

Crock-pot or slow cookers are making a comeback in American culture. Sales are on the upswing and people are dreaming up new recipes for their crock-pots. The only problem is that the clean up after a day of slow cooking food can be messy and very time consuming. This is the downside to slow cookers and one reason people dislike using them often.

Sometime ago people thought of using cooking bags in their slow cookers to make cleanup a snap. For cleanup, they worked great! It was a snap to clean as none of the food in the pot touched the sidewalls or bottom. The bags rarely, if ever, stuck to the pot, so the cleanup was very easy.

There was a problem though. The plastic in the bags would leach out of the bag and on to the food in small quantities. While not considered a danger to people by the FDA, companies began pulling their products. That was until Reynolds, the producers of Reynolds Wrap, developed a plastic bag for slow cookers. Reynolds had taken out the one ingredient that was of most concern leeching into food, Biphenyl A (BPA).

Today several companies are now producing similar bags without this element in them, thus they are all fine for use in slow cooker. People can now take a bag of frozen food place it in a slow cooker, letting it cook all day long and ready to eat when they get home. Little clean up, little prep time, and they do not have to worry about chemicals leeching into their food.

However, the new problem with these bags from all the different companies is that they are one use and then done. The bags are not developed to be resealed or closed up for convenience.

There is an issue with a rectangular shaped bag as a rectangular freezer bags are difficult to use and fit into an oval pot while frozen rock solid.

There is still room for improvement in the art.

### SUMMARY OF THE INVENTION

The object of the current invention is to provide a solution of non-reusable crock pot bags by allowing the re-usable product to be resealed with either a zipper or sealing mechanism on the bag.

The present invention is a crock pot container or bag. It is a reusable silicone “bag” in the shape of the most commonly used crock pots (oval or round according to the dimensions of the specific crock pots). The container would have a opening which is sealable with a fully water proof sealable zipper that would make it easy to fill, and empty even when frozen.

The container would have a spot to label the contents of the bag and date created and modern/contemporary design styles. The containers could be designed to be stackable.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows the current invention and its main components; and

FIG. 2 shows the containers fitting into a holder.

### DESCRIPTION OF THE PREFERRED EMBODIMENT

There are a number of significant design features and improvements incorporated within the invention.

The present invention is a crock pot container or bag 1 It is designed to help people like working moms or dads who want to make freezable crock pot meals ahead.

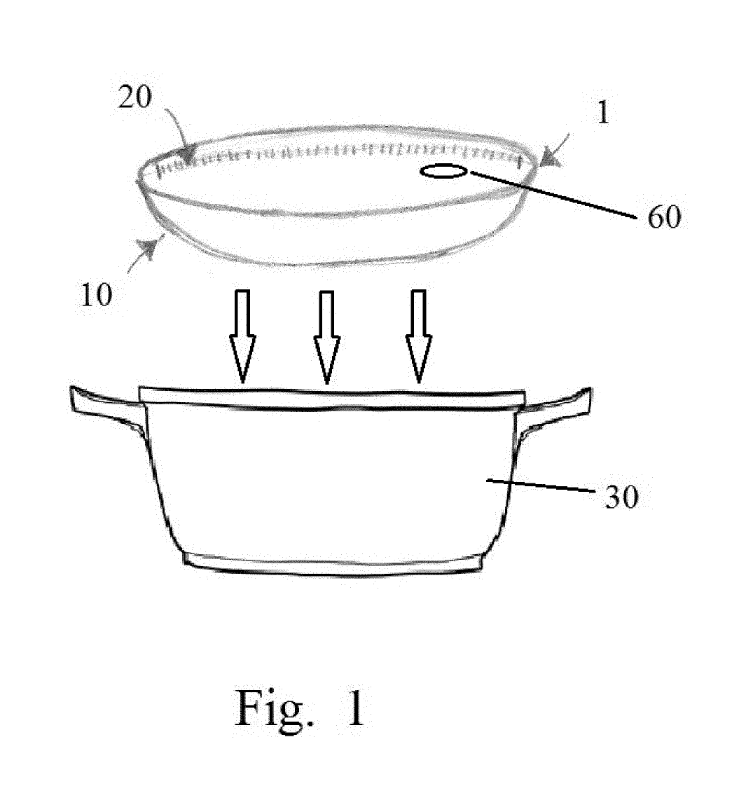

The crock pot bag 1, as shown in FIG. 1, is a reusable silicone container 1 or bag that is in the shape of the most commonly used crock pots 30. These shape can be oval or round bottom 20 according to the dimensions of the specific crock pots 30.

In the preferred embodiment, the container 1 or bag is made of silicone which is a unique polymer containing silicon although other appropriate materials can be used.

The bag or container 1 would have an opening 10 which would be sealable with a sealing means such as a fully sealable zipper. The opening 10 makes it easy to fill with the ingredients that the user wants to cook, and to empty even when frozen which can be a problem with a rectangular shaped freezer bags. It is designed to just flip inside out to clean and re-use regularly. It makes it easier to “Dump and Go” with cooking.

The ingredients are placed into the container 1. The container 1 can be placed into a freezer or refrigerator to be stored until used. The container 1 is placed into a slow cooker/crock pot 30 when the user wants to cook it. The ingredients are cooked while being held in the container 1 in the slow cooker/crock pot 30. The cooked ingredients can be served out of the container 1 or dumped out into the slow cooker/crock pot 30 or a bowl or serving dish. The container 1 with the cooked ingredients can also be frozen in the container 1 to be served and eaten later.

In the preferred embodiment, the container 1 would have a label spot 40 which can be used to label the contents of the bag and date created and modern/contemporary design styles.

The preferred size is one 1 gallon which would be approximately 4-6 servings.

The contents of the bag 1 can be both frozen and cooked in the bag 1.

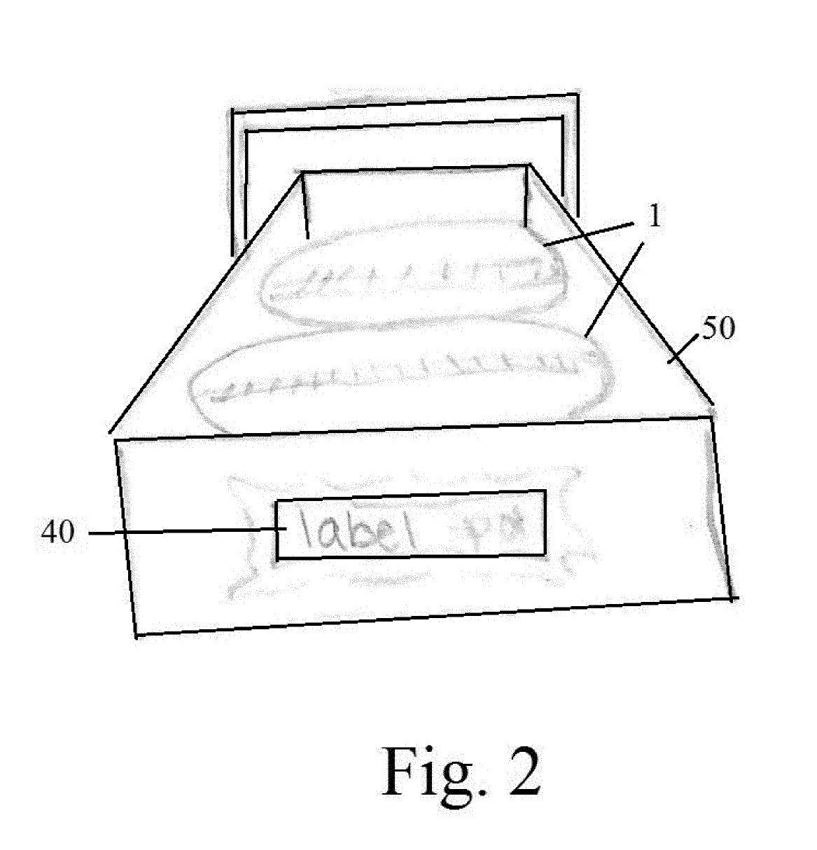

As shown in FIG. 2, the bags 1 can be part of a freezer storage system with pull out “drawers” 50 in which the bags 1 are place and stored to get to particular meal easily without having to move entire “stack”.

The bag 1 can have a port 60 to vacuum pack for longer storage.

### ADVANTAGES

The current invention offers a number of conveniences. It is easier to throw the container into a crock pot on the way out the door. It makes it easier for users to make a better effort to feed their family wholesome meals in food safe, BPA free container as the after school/work rush that can make for poor meal choices. It can reduce costs are it allows a user to capitalize on coupons, deals, and club memberships.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a reusable silicone container with a rounded bottom with a resealable opening to hold ingredient while the ingredient are cooked.

2. The device as recited in claim 1, further comprising:
where the container is a bag.

3. The device as recited in claim 1, further comprising:
where the opening is sealed with a zipper.

4. The device as recited in claim 1, further comprising:
where the container is in the shape of the most commonly used crock pots.

5. The device as recited in claim 1, further comprising:
having a label.

6. The device as recited in claim 1, further comprising:
being stackable.

7. The device as recited in claim 1, further comprising:
placing the container into a slow cooker.

8. The device as recited in claim 7, further comprising:
placing the container into the freezer.

9. The device as recited in claim 7, further comprising:
placing the container into a crook pot.

10. The device as recited in claim 9, further comprising:
heating the ingredients using the crock pot.

11. The device as recited in claim 10, further comprising:
removing the container from the crock pot and emptying the contents.

12. A process to track an item using the device in claim 1 to cook.

13. A cooking process comprising:
having a reusable silicone container with a rounded bottom with a resealable opening,
placing ingredients into the container,
placing the container into a slow cooker,
heating the contents of the container using the slow cooker for a specific amount of time,
removing the container from the slow cooker.

14. The cooking process as recited in claim 13, further comprising:
where the opening is sealed with a zipper.

15. The cooking process as recited in claim 13, further comprising:
where the container is in the shape of the most commonly used crock pots.

16. The cooking process as recited in claim 13, further comprising:
having a label.

17. The cooking process as recited in claim 13, further comprising:
the container being stackable.

18. The cooking process as recited in claim 13, further comprising:
placing the container into the freezer.

19. The cooking process as recited in claim 13, further comprising:
removing the container from the crock pot and emptying the contents.

20. The cooking process as recited in claim 13, further comprising:
where the container is a bag.
